(19) United States
(12) Patent Application Publication
(10) Pub. No.: US 2026/0298021 A1
(43) Pub. Date: Oct. 1, 2026

(54) SMOKE CURTAIN SEALING

(71) Applicant: BLE Smoke & Fire Curtains Limited, Sheffield (GB)

(72) Inventor: David Bramhall, Sheffield (GB)

(21) Appl. No.: 19/441,355

(22) Filed: Jan. 6, 2026

(30) Foreign Application Priority Data
Mar. 31, 2025 (GB) 2504790.3

(51) Int. Cl. E06B 9/17; E06B 9/13

(52) U.S. Cl. CPC E06B 9/17; E06B 9/13

(57) ABSTRACT

A smoke curtain assembly comprises a curtain housing 401 for a smoke curtain, a smoke curtain 500 having a first side magnetic strip 503 and a second side magnetic strip 504, a roller 501 for winding up the curtain for storage in the headbox, a motor and shaft in the curtain housing, and a pair of drawstrings to draw the roller into the curtain housing. A lateral magnetic strip 505 is attached to the curtain which draws the curtain material to a ferromagnetic surface surrounding an opening to be covered by the smoke curtain.

### FIELD OF THE INVENTION

The present invention relates to smoke curtains.

### BACKGROUND OF THE INVENTION

Smoke curtains are used in ships, industrial buildings, commercial buildings and publicly accessible buildings such as shopping centres, hospitals, industrial warehouses, and like buildings to isolate areas of a building or structure against the passage of smoke from one region to another in the event of a fire. The smoke curtain drops down to cover a clear opening between regions or areas when there is a smoke alarm event, sealing off the opening. Areas to be isolated may include doors, corridors, lifts (elevators), lift shafts, lift shaft openings, balconies or other like architectural structures.

A present known product for a smoke curtain, comprises a curtain housing, also called a head box which contains a rolled-up fabric smoke curtain, such that the rolled-up curtain unrolls and drops down to seal an opening when there is a smoke alarm. There is a metallic surround to the opening which is sealed by magnetic attraction of the side of the curtain to a pair of metallic side rails as the curtain unrolls and lowers. One downside of this arrangement is that there needs to be a ferro-metallic frame around the opening, with vertical rails extending above the opening, and this does not make the installation visually attractive to architects who like to have clean lines around the opening. At the moment there need to be auxiliary rails all the way up the sides of the opening and extending to the ceiling where the curtain housing is located.

An alternative prior art arrangement is that the curtain housing containing the curtain is placed immediately above the opening, which architects also do not like visually because the curtain housing is bulky and visually obtrusive.

The architect or end user wants to put the curtain housing as far as possible above the opening in order to hide the curtain housing, and to remove the auxiliary rails between the top of the elevator and the curtain housing which they see as being unsightly, whilst at the same time when deployed in use, the smoke curtain must be sealed to the opening surround so as to not to let any smoke pass from one side of the opening to another.

Known smoke curtain installations are limited in that they either have to position the curtain housing directly above the top of the surround, or alternatively there needs to be a frame comprising vertical auxiliary rails extending from the top of the surround to the lower part of the curtain housing where the curtain housing is placed with a significant height gap above the top of the surround. Both of these options are visually unattractive and are unappealing to architects when specifying a smoke curtain installation.

The primary function of a smoke curtain is to isolate an area or room in which there is smoke from surrounding areas or rooms in order to prevent the propagation of smoke through buildings or ships. The primary function must be achieved, whilst taking into consideration secondary criteria of being architecturally attractive, or if not attractive then at least as unobtrusive as possible.

Referring to FIG. 1 herein, there is illustrated schematically a known smoke curtain installation 100 fitted around an architectural opening such as for example a doorway in a corridor or between rooms in a building, ship, elevator, elevator shaft or the like. The smoke curtain installation comprises an outer frame 101 secured fully or partially to a surround around a clear opening, a flexible curtain 102 which can be rolled up or down, and a curtain housing 103 into which the curtain can be retracted.

In use, the curtain is normally retracted into the curtain housing 103 and is rolled around a horizontal roller 105 located inside the curtain housing. When the curtain is deployed when smoke is present, a door 104 on the underside of the curtain housing 103 releases the roller 105, and the curtain drops downwards under gravity unrolling the curtain as it drops and closing off the opening. Flexible magnetic strips on either side of the curtain are attracted to a pair of ferromagnetic strips or rails on the frame, one either side of the opening, to make a smoke-tight seal around the opening.

Smoke curtains are not quite the same as fire curtains and there are some differences between the two. In general, for a smoke curtain the curtain material itself is made of a fabric, and the curtain has a metallic bottom bar, the weight of which overcomes the resistance of an electric motor in the curtain housing, so that the curtain drops under gravity, overcoming the passive resistance from turning the electric motor. The electric motor in the curtain housing is used to retract the curtain again in the event of false alarm, or when the smoke event is finished.

In order to make a smoke-tight seal around the curtain, the edges of the curtains are provided with flexible tape of a magnetic material, which lies adjacent a magnetic strip on the outer frame which is secured to the surrounding wall or surface around the perimeter of the opening. As the curtain unrolls, the unrolling magnetic tape is attracted to the flat ferromagnetic metallic strips at the sides of the frames, retaining the edge regions of the curtain to the frame. The frame itself is secured to the surrounds of the opening, which can be for example a wall, elevator surround or the like such that there is a gas-tight seal between the frame and the surrounding wall, preferably which remains gas-tight under smoke or fire conditions for at least a minimum predetermined time period.

There are standards for smoke leakage which need to be complied with, such as the UL 1784 Standard For Air Leakage Tests Of Door Assemblies And Other Opening Protectives. For elevator applications, it should be ensured that in the event of a smoke detection event or smoke alarm, the roller 105 deploys from its housing, the smoke curtain seals to the frame, and the whole assembly prevents smoke from either getting into or out of the elevator, or into or out of the elevator shaft. That is to ensure that the smoke curtain acts as a protective smoke barrier between the elevator or elevator shaft and the environment around the elevator.

Referring to FIG. 2 herein, there is illustrated another form of known smoke curtain installation 200 comprising a casing or housing 201 for housing a normally rolled up and retracted fabric smoke curtain; and a frame comprising first and second upright metallic side strips 202, 203, also called auxiliary rails, arranged on a flat surface on either side of a clear opening 204, for example a door, window portal or an opening in a façade. The metallic auxiliary rails extend all the way from the floor either side of the opening up to the ceiling, to the underside of the curtain housing.

Due to aesthetic considerations the curtain housing for the roller which carries the smoke curtain when stored is placed high above the opening and therefore needs to be longer than the minimum area needed to cover the clear opening. When the curtain is deployed in the extended position, a hinged door on the underside of the housing 201 opens and the curtain drops under the force of gravity. The flexible metallic tapes or strips near the edges of the curtain line up with the magnetic rails of the frame affixed to the surrounding wall either side of the opening, which extend from the floor all the way up to the underside of the casing or housing, so when the curtain is extended smoke cannot leak through any gaps at the sides of the curtain or around the housing 201, and so cannot pass from one side of the curtain to another.

However, the known smoke curtain installation is visually obtrusive, having a bulky curtain housing to contain the curtain and in the case of the elevated curtain housing version, having a frame comprising a pair of broad metallic rails extending all the way to the ceiling. Visually this is not favoured by architects when designing public buildings because the auxiliary rails extending up to the curtain housing are permanently visible when the curtain is stored in the curtain housing. However, the curtain housing and metallic strips are functionally necessary if a gas-tight seal is to be maintained across the opening to isolate a first area on one side of the opening from a second area on another side of the opening.

Removing the portion of the metallic auxiliary rails between the top of the opening and the ceiling or the underside of the curtain housing creates the problem that smoke could pass between the curtain and the top of the opening, and out of the gap between the sides of the smoke curtain at the wall surround, where the auxiliary rail portions have been removed.

Referring to FIG. 3 herein, when there is a smoke alarm event the lower door of the curtain housing 201 opens and the curtain drops down under gravity assisted by the weight of the roller 300 across the lower end of the curtain bottom. When the curtain is deployed, the opening is sealed off by the smoke curtain and substantially the whole area of the curtain on the side facing the opening up to the curtain housing is exposed to smoke. The seal around the curtain to the surrounding wall is provided by the two upright magnetic seal strips on the curtain which seal to the upright members (auxiliary rails) of the frame either side of the curtain, and which extend all the way from the floor up to the curtain housing, and by a horizontal seal positioned at the curtain housing which seals the curtain to the curtain housing, and at the bottom of the curtain by the roller beam touching the floor. The top seal which seals the curtain sheet to the curtain housing comprises a metallic strip having an adhesive foam backing, which is located over the curtain film and then attached to the wall using screw fixings, to compress the seal and secure the top of the curtain to the wall in a smoke impermeable manner.

Known smoke curtains can be difficult to install. Because of the mechanical properties of the known curtain fabric, which is usually made from a polymer being a transparent acrylic film, when the curtain drops, it is difficult to control the unrolling of the fabric without having any metal rails either side of the curtain.

In the case of fitting a smoke curtain to an elevator, there are two elevator types. The first elevator type has a metal frame of ferritic material all the way around the opening, and the second elevator type has non-ferritic material surrounding the opening. If the facing surround around the opening is non-ferritic, then the upright magnetic strips on the curtain will not attract to the surround, and it is necessary to fit ferritic metal upright frame members either side of the opening so that the smoke curtain can be magnetically attracted to the frame to create a smoke impermeable seal. The ferritic upright members can either be relatively short if the curtain housing is immediately above the opening, or if the curtain housing is spaced apart from and at a significant height above the opening, for example around 3 metres or so above the floor level then the upright metal frame strips need to extend all the way from the floor up to the underside of the curtain housing.

The current known smoke curtain installations are either of the type shown in FIG. 1 herein where the curtain housing is installed directly over the opening, and is therefore visible at all times, or of the type shown in FIGS. 2 and 3 herein, where the ceiling is much higher than the top of the opening, and the curtain housing is installed just below ceiling height and the auxiliary metal rails extend either side of the opening and all the way up to the underside of the curtain housing and are visible when the curtain is in the storage position.

### SUMMARY OF THE INVENTION

According to a first aspect there of the present invention, there is provided a smoke curtain comprising:
a flexible web of material having a first side, a second side and an outer perimeter extending around said first and second sides;
said perimeter comprising an upper edge, a lower edge, a first side edge extending between said upper and edge and said lower edge, a second side edge extending between said upper edge and said lower edge, said first and second side edges spaced apart from each other; and
a region of magnetic material extending between said first and second side edges and located at a position between said upper and lower edges.

Preferably said region of magnetic material comprises an upper boundary and a lower boundary, and at least one of said upper or lower boundaries extends diagonally across a line perpendicular to said first and/or second side edges.

At least one of said upper and lower boundaries may extend at an angle of between 1° and 10° relative to a line perpendicular to a said first or second side edge.

Preferably at least one of said upper and lower boundaries extends at an angle of between 3° and 6° relative to a line perpendicular to a said first or second side edge.

Said region of magnetic material may comprise an upper edge which extends diagonally across a line perpendicular to said first and/or second side edges; and
a lower edge which extends diagonally across a line perpendicular to said first and/or second side edges.

Preferably said region of magnetic material forms a quadrilateral.

Preferably said region of magnetic material comprises at least one straight edge or boundary.

Said region of magnetic material may comprise at least one curved edge of boundary.

Preferably region of magnetic material may comprise a magnetic strip separate from said web of smoke resistant material, said magnetic strip extending between said first and second side edges; and
further comprising an adhesive strip for adhering said magnetic strip to said web of curtain material.

Preferably said region of magnetic material is flexible enough to be rolled up along with said web.

Preferably said region of magnetic material is positioned at least 30 cm away from said upper edge of said web.

Said region of magnetic material may be positioned at least 60 cm away from said upper edge of said web.

Said region of magnetic material may be positioned 90 cm or more from said upper edge of said web.

Preferably said region of magnetic material comprises one or a plurality of permanent magnets.

Said region of magnetic material may comprise a ferromagnetic material.

Preferably there is provided a laterally extending securing means located at an upper end of said web for securing said smoke curtain to a curtain housing or to a wall or to a surround, wherein said magnetic region is spaced apart from said laterally extending securing means at a position further down the curtain.

According to a second aspect there is provided a smoke curtain assembly comprising:
a flexible smoke curtain comprising an elongate web of material having an upper end and a lower end, a first side edge, and a second side edge;
a container for housing said smoke curtain;
a roller for carrying said smoke curtain; and
characterised in that:
said curtain has a laterally extending magnetic strip extending across the width of the curtain between first and second sides of said curtain.

Preferably said laterally extending magnetic strip extends diagonally along a width and length of said curtain at an angle of between 1 ° and 10 ° to a line perpendicular to said first and/or second side edges.

Preferably said laterally extending magnetic strip extends diagonally along a width and length of said curtain at an angle of between 3 ° and 6 ° to a line perpendicular to said first and/or second side edges.

The smoke curtain assembly may further comprise a magnetic frame for fitment to a wall or to a surround of a said opening.

Preferably the smoke curtain assembly comprises a first upright rail of magnetic material, and a second upright rail of magnetic material.

Preferably said laterally extending magnetic strip extends between said first and second upright rails.

Preferably, in use, said container is located at a distance from said a lower part of each upright rail, such that neither the first or second upright rails extend as far as a base of the container.

Preferably, when said curtain is in extended condition, a distance between said magnetic region of said curtain, and an upper edge of said curtain is at least 30 centimetres.

When said curtain is in an extended condition, a distance between said magnetic region of said curtain, and an upper edge of said curtain may be at least 60 centimetres.

When said curtain is in an extended condition, a distance between said magnetic region of said curtain, and an upper edge of said curtain may be at least 90 centimetres.

According to a third aspect there is provided a method of installing a smoke curtain to surround structure around a clear opening in a building, or ship, said method comprising:
securing a smoke curtain container to said opening surround above said opening, and spaced apart from said opening;
securing an upper part of a smoke curtain to said container, or to said opening surround; and
attaching a strip of magnetic material to said smoke curtain at a distance along said smoke curtain which is spaced apart from a location where said smoke curtain is attached to said container or said opening surround, and which is above an upper perimeter of said opening.

Preferably said strip of magnetic material is attached to said smoke curtain laterally across a width of said curtain.

Preferably said magnetic strip is attached to said smoke curtain using an adhesive strip.

Preferably the magnetic strip extends at an angle of between 1 ° and 10 ° to a straight line which is perpendicular to side first and second side edges of said curtain.

Preferably, the magnetic strip comprises a permanent magnet.

Preferably the magnetic strip is flexible enough to be rolled up along with said curtain when said curtain is rolled into a spiral.

Preferably the container is spaced apart from said magnetic strip attached to said curtain by at distance at least as high as a height of said container.

The clear opening may comprise an elevator portal leading to an elevator door set.

Other aspects are as set out in the claims herein.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 herein illustrates schematically a first prior art smoke curtain installation having a curtain housing container located immediately above a clear opening to be closed by a smoke curtain;

FIG. 2 herein illustrates schematically a second prior art smoke curtain installation having a curtain housing container located a distance above an upper extremity of a clear opening to be closed by a smoke curtain, with the curtain in a stored configuration;

FIG. 3 herein illustrates schematically the second prior art smoke curtain installation of FIG. 2 herein, having a curtain housing container located a distance above an upper extremity of an opening to be closed by a smoke curtain, with the curtain in deployed configuration covering the opening;

FIG. 4 herein illustrates schematically an automatic smoke curtain assembly according to a specific embodiment of the present invention, installed in situ to cover a clear opening to be closed, the assembly having a curtain housing container located a distance above and away from an upper extremity of the opening to be closed by a smoke curtain, with the curtain in a retracted or stored position;

FIG. 5 herein illustrates schematically the smoke curtain installation of FIG. 4 having a curtain housing container located a distance away from an upper extremity of an opening to be closed by a smoke curtain, with the curtain in deployed and extended position;

FIG. 6 herein illustrates schematically in view from one side, an extended smoke curtain according to a specific embodiment of the present invention;

FIG. 7 herein illustrates schematically in cutaway view, a detail of a magnetic attachment of a smoke curtain to a laterally extending portion of a metallic frame to create a smoke-impermeable seal across a perimeter of an opening to be sealed;

FIG. 8 herein illustrates schematically an overlay of a laterally extending magnetic strip with a laterally extending ferromagnetic metal strip to provide a smoke-impermeable seal between a smoke curtain and the metal strip, where the magnetic strip and metallic strip lie across each other at a predetermined angle;

FIG. 9 herein illustrates schematically the laterally extending magnetic strip and metallic strip of FIGS. 7 and 8 at a first stage of detachment from each other when the curtain is being raised by the motor in the curtain housing container, showing an initial stage of disengagement of the magnetic and metallic strips to release the smoke impermeable seal;

FIG. 10 herein illustrates schematically the laterally extending magnetic strip which is attached to the curtain at an angle θ to a line A-A′ perpendicular to each of the side edges of the curtain;

FIG. 11 herein illustrates schematically a second embodiment laterally extending magnetic strip for a smoke curtain and its orientation to a line A-A′ perpendicular to each of the side edges of the curtain;

FIG. 12 herein illustrates schematically a third embodiment laterally extending magnetic strip for a smoke curtain having a substantially horizontal upper edge and an angled lower edge having its orientation to a line A-A′ which is perpendicular to each of these side edges of the curtain when hanging vertically downward at an angle θ;

FIG. 13 herein illustrates schematically a fourth laterally extending magnetic strip having an upper edge which is substantially horizontally oriented in use, and the lower edge which is oriented at an angle θ to the horizontal and to a line A-A′ which is perpendicular to the upright sides of a smoke curtain, when in use;

FIG. 14 herein illustrates schematically a fifth laterally extending magnetic strip having an upper edge which, in use is angled at an angle θ₁ to the horizontal and to a line A-A′ extending perpendicular to each of the side edges of a curtain, and having a lower edge which is at an angle θ relative to the horizontal line A-A′;

FIG. 15 herein illustrates schematically a sixth laterally extending magnetic strip having an upper edge which, in use is angled at an angle θ₁ relative to a line A-A′ extending perpendicular to each of the side edges of a curtain, and having a lower edge which is at an angle θ relative to the line A-A′;

FIG. 16 herein illustrates schematically a seventh laterally extended magnetic strip having a curved upper edge and a curved lower edge, relative to a line A-A′ extending perpendicular to a main length direction of a smoke curtain, and perpendicular to each side of the smoke curtain;

FIG. 17 herein illustrates schematically the smoke curtain of FIG. 4 from one side, in an extended position; and

FIG. 18 illustrates schematically a detail of a lower part of the smoke curtain in partially deployed condition as it is rolled up or down the auxiliary rails.

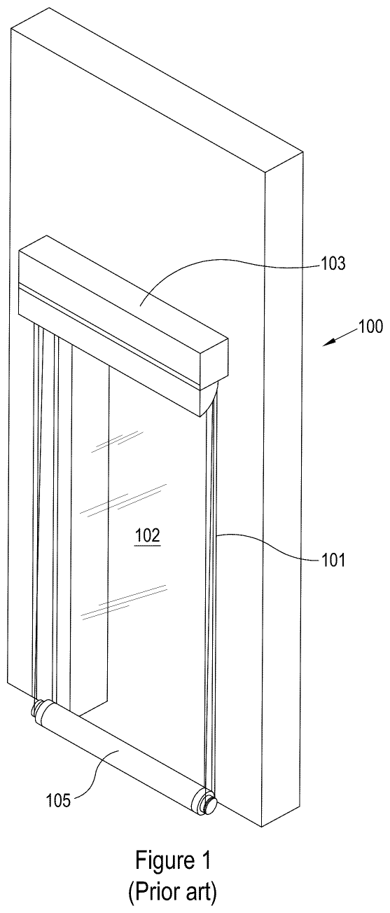

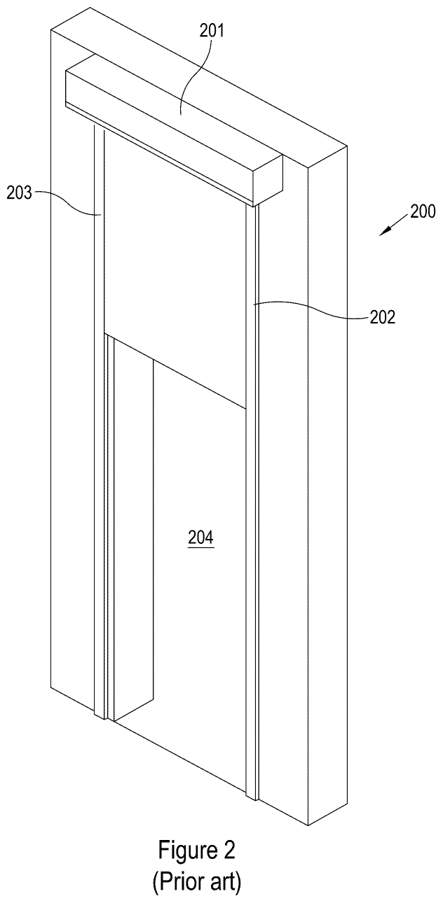

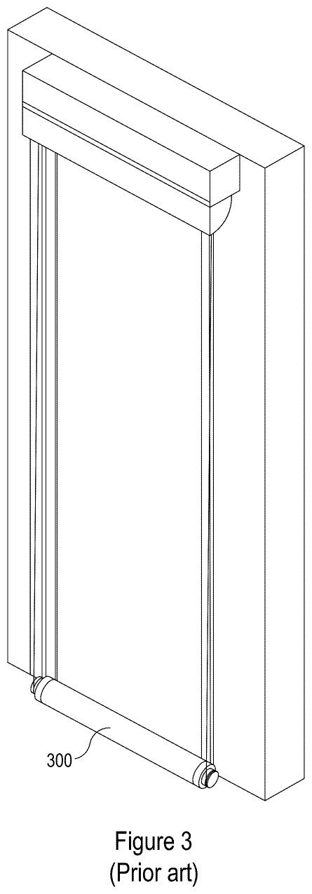

### DETAILED DESCRIPTION OF THE EMBODIMENTS

There will now be described by way of example a specific mode contemplated by the inventors. In the following description numerous specific details are set forth in order to provide a thorough understanding. It will be apparent however, to one skilled in the art, that the present invention may be practiced without limitation to these specific details. In other instances, well known methods and structures have not been described in detail so as not to unnecessarily obscure the description.

In this specification, the term magnetic material is used to include permanent magnets, ferromagnetic materials containing iron, and materials which would be attracted to a permanent magnet.

In this specification the term opening is used to describe a normally clear opening such as a door opening, corridor, portal between different rooms or areas of a building, elevator opening, aperture or the like, which may be closed off by a smoke curtain under a smoke alarm condition or a smoke event.

In this specification, the terms “lift” and “elevator” are used interchangeably to mean the same thing. Elevator is an American term, and lift is a British term for the same type of machinery. Both refer to a device that carries people and/or goods to different levels in a building, ship or like construction.

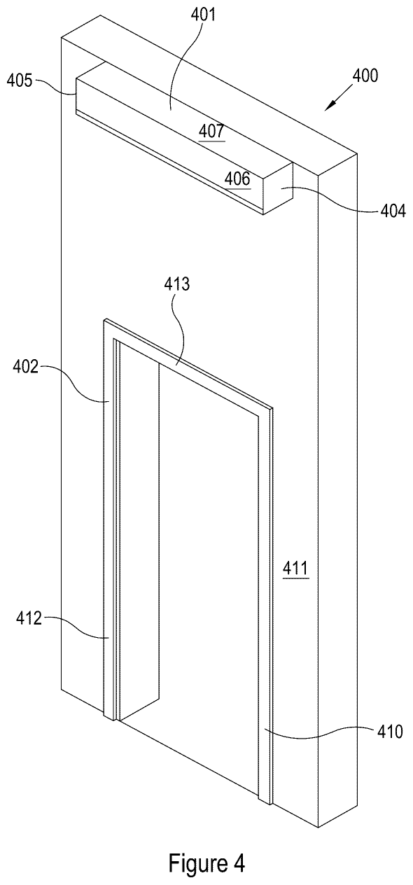

Referring to FIGS. 4 to 10 of the accompanying drawings, there is disclosed an automatic smoke curtain assembly according to a specific embodiment of the present invention. In use, the smoke curtain automatically deploys to cover a clear opening when there is a smoke alarm event, and can be retracted again to a stored condition for re-use, when the smoke alarm event is over. The disclosed smoke curtain assembly avoids having the portion of the prior art frame's upright or vertical auxiliary rails which extend substantially from the top of a perimeter around a clear opening all the way up to the base of the curtain housing which contains the stored smoke curtain, thereby improving the aesthetic appearance of the installation.

The challenge with removing the portion of the prior art upright auxiliary rails which extend above the clear opening is that if the auxiliary rails are removed, this creates an air gap between the curtain and the clear opening, and smoke can pass between the upper edge of the clear opening and the smoke curtain and leak out past the smoke curtain into the adjoining space on the other side of the curtain, undermining the basic function of the curtain as a smoke-proof barrier.

In the presently disclosed solution, a laterally extending magnetic strip is inserted above the horizontal upper part of the clear opening, between the upright rails of the frame (along the top beam of the clear opening), so that there is an unbroken seal all around the sides and upper portion of the clear opening, without the need for the auxiliary rails to go all the way up to the top of the curtain housing container. There is one strip of magnetic material fitted horizontally across to form the top of the frame, which can be a permanent magnet metal or other magnetic material, and another strip which is attached to the curtain, preferably at a slight angle of 3° to 6° to the horizontal so that it is not exactly parallel to the horizontal strip on the frame surrounding the clear opening. When the curtain comes down, smoke cannot get behind the curtain above the frame, as once the curtain drops down over the upper part of the frame, it seals to the upper horizontal part of the frame by virtue of the magnetic strip on the frame and a lateral magnetic strip on the curtain. The lateral strip on the curtain is angled slightly relative to the corresponding strip on the frame around the opening so that when the curtain is retracted again after deployment, the curtain gradually detaches from the frame, gradually overcoming the magnetic attraction between the magnetic strip on the curtain and the corresponding magnetic strip on the frame as the curtain is raised.

Under a smoke event condition, the curtain drops under gravity and so the crossing of the strip on the curtain relative to the horizontal strip on the frame means that the attachment does not cause the curtain to stick when dropping the last part to fully cover the opening. Also on the return retraction, when the curtain is retracted under power of the electric motor, the two magnetic strips slide or peel away from each other more easily and with less force than if the two strips were exactly parallel to each other. The lateral metallic or magnetic material strips on the frame can be retro fitted by use of an adhesive backing and/or fixings such as screws. The presently disclosed embodiment does not have to have an upright auxiliary rail extending above the top of the opening but still has a magnetic or metallic strip laterally between the two upright auxiliary rail portions of the frame.

On the curtain, there is a laterally extending magnetic strip slightly angled to the horizontal, so that as the curtain deploys when it reaches the top of the frame, the magnetic strip adheres to the top of the frame. The magnetic strip on the curtain is angled slightly relative to the metallic strip on the wall or surround to the clear opening, and is angled relative to the perpendicular to the upward/downward motion direction of the curtain, so that the forces needed to overcome the attraction between the curtain and the horizontal upper part of the frame are reduced. The advantage is that the vertical auxiliary rails above the frame can now be dispensed with, giving a better visual appeal to architects and customers without loss of functionality and whilst maintaining a good seal against smoke around the clear opening of the elevator.

The magnetic materials may include active permanent magnets, made from magnetically hard materials made from alloys, consisting of varying amounts of iron, aluminium, nickel, cobalt and rare earth elements samarium, dysprosium, and neodymium, and passively magnetic materials such as metals containing iron.

The embodiments may work with two laterally extending magnetic strips facing each other, one attached to the curtain and the other comprising an upper cross part of a frame attached to a surrounding face to the door, portal, or other clear opening to be protected by the smoke curtain. In a best mode embodiment, a single permanent magnet and a ferromagnetic material would be used. The ferromagnetic material could comprise a separate component flat strip of ferromagnetic metal attached to the surrounding face laterally and above an opening to be closed by the smoke curtain.

Alternatively, if the surround to the clear opening is already a flat or planar ferromagnetic surface, the ferromagnetic material could be the existing ferromagnetic surround to the opening, for example a stainless steel wall facing, or a painted steel surface.

Referring to FIG. 4 herein, there is illustrated schematically a smoke curtain installation according to a specific implementation of the present invention fitted to close off a clear opening, in this case an opening leading to an elevator door, during a smoke alarm event.

The smoke curtain installation 400 comprises a curtain housing 401, being a container or housing to contain a curtain wrapped around a roller, and a frame 402 which extends around an opening to be sealed off by the curtain in the event of a smoke event.

The curtain housing 401 comprises an upper panel 403, a first end panel 404, a second end panel 405, a front panel 406, a rear panel, and a lower swing door 407 panel, the curtain housing box further comprising an elongate rotatable rod or shaft held inside of the box substantially horizontally between first and second roller bearings contained within the curtain housing, a battery, an electric motor, also inside the box, capable of rotating the rod or shaft either clockwise or anti-clockwise to raise or lower the curtain, and a control circuit for controlling the motor to raise the curtain. The rotatable rod has first and second pulleys or bobbins around each of which is wound a corresponding respective suspension cord which is used for lowering and raising a roller 501. Preferably the suspension cords are made of aromatic polyamide (aramid) fibres, which remain stable under fire or above standard room temperature heat conditions. The electric motor, battery and control circuit are housed within the curtain housing, which gives those components some degree of protection against external smoke, fire and heat.

The frame 402 around the opening comprises a first metallic upright strip 410, which is positioned on a first side of a front face 411, for example a wall or encasement surrounding the opening; a second metallic upright strip 412, intended for positioning on the face 411 on an opposite side of the opening and spaced apart from the first upright frame member 410; and an upper metallic strip 413 intended to extend across the top of the opening and to be fixed to the face 411, so that the first upright, second upright and upper metallic strips are formed into three sides of a rectangle all lying in a same upright plane.

In some installations, the front face 411 may itself be an existing metallic surface as part of a building or structure, for example a stainless steel façade or wall covering, in which case the first and second uprights 410, 412, and the upper cross member 413 are not discrete components, but are regions of the face 411 or an existing structural metal surround, and the curtain can attach magnetically directly to the existing metal surround structure, façade or wall.

There is provided a strip securement between the uppermost part of the smoke curtain and the curtain housing which secures the curtain to the curtain housing and prevents the whole curtain falling down when deployed, however unlike the prior art, the upper metal strip seal at the headbox is no longer relied on to create a smoke impermeable seal between the two sides of the curtain film. In the present embodiment, the seal at the curtain housing comprises a metal strip with an adhesive foam backing which extends across the width of the curtain and which is secured with screws or like fixings to compress the curtain to the curtain housing, and also to hold the upper end of the curtain without tearing when it is left to deploy under gravity.

Instead of having auxiliary rails (upright metal frame members) which extend all the way from the floor up to the curtain housing as in the prior art installation, in the presently disclosed solution, the auxiliary rails extend each side of the opening to be protected up to a position just above the opening and then are connected by the upper rail member (upper frame member), similar to the layout of a door architrave. In the presently disclosed embodiments, there is no need for the auxiliary rails to extend all the way up to the headbox.

Typically, the distance between the underneath of the curtain housing and the lateral ferritic metal strip seal across the top of the opening is at least 30 centimetres, and can be up to 2 metres.

### Typical Curtain Housing Dimensions May Be:

distance projecting from the wall—21 cm+−15%;
width of headbox—106 cm to 132 cm+−15% of each figure; and
height of headbox—25 cm+−15%.

In FIG. 4, there is shown an installation in which the face 411 surrounding the opening is substantially flat and planar. However, in other types of deployment, for example around an elevator portal, an existing surrounding to the portal may project out from the rest of the wall up to the ceiling. Such a projection of up to 10 cm can be accommodated without spacing the curtain housing away from the wall when mounting it to the wall, as the roller will pass over the projecting surround without being impeded on its downward trajectory. However, for surroundings which project by more than 10 cm, it may be necessary to insert a spacer between the rear of the curtain housing and the wall above the surrounding to align the curtain housing with the projecting surrounding around the opening so that the curtain falls vertically in front of the projecting surround and in a same vertical plane as the plane of the face of the opening surround.

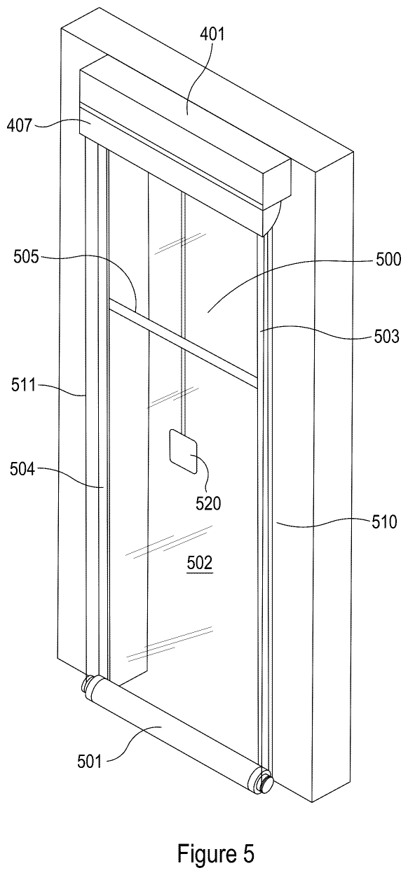

Referring to FIG. 5 herein, there is illustrated schematically the smoke curtain installation of FIG. 4, where the curtain 500 has been fully lowered and extended to cover the opening. When the lower panel of the curtain housing has opened, the lower end of the smoke curtain drops down under gravity assisted by the weighted roller beam 501 attached to the curtain. The roller beam 501 has attached chords 510, 511 one either side of the beam for pulling up the roller, so that when the curtain sheet is retracted again, the weight of the roller 501 is borne by the chords which are wound round respective pulleys or bobbins at each end of the shaft in the curtain housing.

A first face on a first side of the unrolled extended curtain contacts the metallic frame around the opening and presents towards the opening, and a second face on an opposite second side of the curtain to the first face, presents away from the opening. The smoke curtain, which was previously in a compacted rolled stored condition in the curtain housing 401 has been released and has unrolled under the influence of gravity, so that the lower end of the curtain contacts the floor at the base of the opening, and so that the face of the curtain which presents towards the opening is in contact with the metallic frame. The side of the curtain which faces away from the opening in this embodiment has first and second magnetic strips 503, 504 respectively attached, the fabric of the flexible curtain is sandwiched between the magnetic material strip of the curtain and the corresponding part of the metallic frame in a gas tight seal which will not permit passage of smoke.

Lateral strip of magnetic material 505 extends across the width of the curtain. In use, when the curtain is hanging vertically downwards, the lateral magnetic strip is angled at a shallow angle θ to the horizontal. The angle which a lower edge of the lateral strip lies compared to a line which is perpendicular to the sides of the curtain is in the range 1 ° to 10 ° and in the best mode, is in the range 3 ° to 6 °. By angling the lateral magnetic strip so that it diagonally crosses the lateral upper frame portion 413 means that when the curtain is drawn up from the deployed state to the retracted state by the motor and roller shaft in the headbox, the lateral magnetic strip 505 detaches or peels away from the lateral metallic strip 413 more easily than if the magnetic strip and metallic strips were to be parallel to each other. As the curtain is raised, due to the orientation of the magnetic strip being at an angle θ to the perpendicular to the upright direction of travel of the curtain, this means that the strip starts to curve at one side slightly before it curves at its other side, when the curtain rolls around the upwardly moving roller.

Central to the curtain sheet and at a height and position which is immediately recognizable to a person standing either side of the curtain sheet is provided an emergency electronic touch control 520 which can be pressed by a person to raise the curtain long enough for them to pass through the opening. T This touch control and the electric wire to it, roll down with the curtain when the curtain is deployed and roll up again with the curtain when the curtain is retracted into the container housing.

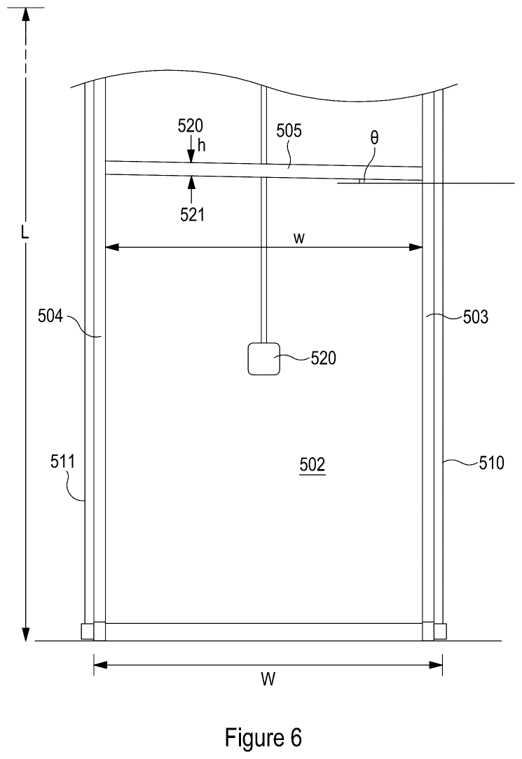

Referring to FIG. 6 herein, there is shown in more detail the smoke curtain in view from the side facing away from the opening. The smoke curtain comprises a flexible web of fabric having a length L, a width W and a web thickness T, a first side, a second side, a first side edge 510, a second side edge 511, a lower edge, in use being wrapped around the roller, and an upper edge, in use being secured near to or near the curtain housing. The upper edge is not shown in FIG. 6 and is normally attached to the roller inside the curtain housing.

The curtain comprises a rectangular web or sheet of transparent or translucent material, preferably an acrylic polymer material. Adjacent a first side edge there is a first flexible strip of magnetic material 503 which can be rolled into a spiral as the web is rolled into a spiral roll for storage, and adjacent a second side edge there is a second flexible strip of magnetic material 504, also capable of being rolled into a spiral as the sheet of web material is rolled up. Extending between the first and second side edges there is the laterally extending region of magnetic material 505. The laterally extending region of magnetic material occupies an area which extends across the width w of the curtain sheet between the parallel magnetic side strips 503, 504 and which extends along a height length of the curtain sheet. The lateral region of magnetic material 505 is spaced apart from the upper edge of the curtain sheet, preferably by a distance of at least 30 centimetres, so that there is at least a 30 centimetre gap and preferably 60 centimetres or 90 centimetres between the upper edge of the magnetic region and the upper edge of the sheet material.

Typically, the lateral strip region 505 of magnetic material has a height h of 3 cm +−2 cm, and an overall width w in a direction across the width of the sheet of between 106 cm and 160cm +−10 %. Preferably the magnetic strip or region forms a parallelogram extending as a diagonal across the width of the curtain sheet, making an angle θ with a line parallel to the upper edge or lower edge of between 1 ° and 10 °, and preferably in the range 3 ° to 6 °, so that as the curtain is pulled up and retracted, the magnetic region on the curtain web gradually peels away from the magnetic region above the opening to be protected.

The magnetic strip region 505 on the curtain preferably has a first, upper edge 520 which extends diagonally across a width of the curtain, between the curtain's first and second side edges, and a second, lower edge 521 which also extends diagonally across a width of the curtain between the first and second side edges. Preferably the first upper edge 520 is parallel to the second lower edge 521, although it does not necessarily need to be so.

Adjacent the first and second side edges there is provided a first upright magnetic strip 503, and second upright magnetic strip 504, each magnetic strip being flexible so that as the web is rolled into a compact spiral, the magnetic strips roll up with the curtain.

In a preferred embodiment, the material of the web is transparent or translucent so that persons on one side of the curtain can see whether there is smoke on the other side of the curtain, but in other embodiments the material may be opaque. For fitment to openings leading to elevators, where the smoke curtain is transparent this enables users of an elevator to ascertain the safety of the environment outside the elevator before egress from the elevator. Typically, the fabric is a transparent acrylic polymer film.

The curtain housing unit can be discreetly installed into ceilings and above elevator frames so as to be visually unobtrusive.

Upon deployment, the curtain film or sheet will safely descend under gravity weighed down by its own weight and the weight of the roller bar 501 attaching to the ferritic elevator frame or to the optional auxiliary rails surrounding the opening, to form an effective smoke seal which limits the spread of smoke throughout the building or ship to which the smoke assembly is fitted.

In order to make the curtain housing installation as compact as possible, the curtain fabric or film is relatively thin so that when rolled it takes up as little space as possible. However using a thin smoke resistant acrylic polymer film also means that the thinner the film, the more prone to tearing or stretching it becomes. The magnetic region 505 is therefore incorporated to the curtain in a manner which minimises the risk of tearing of the curtain sheet material, by sticking the strip region with adhesive to the curtain sheet.

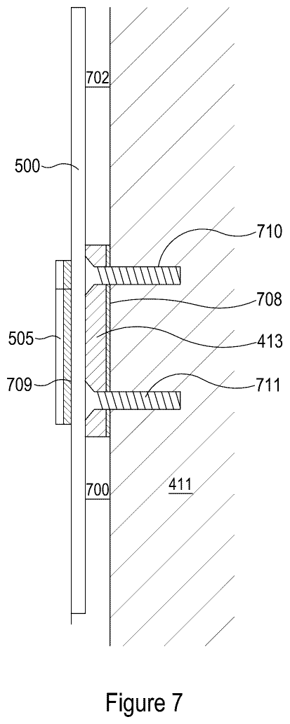

Referring to FIG. 7 herein, there is illustrated schematically in cut away view from one side, attachment of the smoke curtain 500 to the outer frame around the opening, and particularly, attachment of the portion of the smoke curtain immediately adjacent the upper frame member 413.

The opening-facing side of smoke curtain 500 contacts the flat outer surface of the metallic lateral strip 413 which extends laterally across the perimeter of the opening. Lateral magnetic strip 505 of the curtain urges the curtain fabric towards the metal frame upper portion 413 so as to make a tight smoke impermeable contact between the surface of the curtain fabric and the upper frame portion 413. Smoke may occupy the void or gap 700 between the curtain fabric and the wall or face 411 on the opening side, below the seal between the magnetic lateral strip 505 and the lateral metallic frame upper portion 413 but cannot pass through the seal to a position 702 above the seal.

In FIG. 7, the upper frame portion 413 is shown as a discrete flat rectangular cross section ferromagnetic metal strip attached to the flat surface 411 using screws 710, 711. Where a separate lateral upper frame portion 413 is provided, it may be attached to the host face or wall using adhesive strip, glue, bonding 708 or other known attachment method or fixings.

In other installations, the flat face 411 may itself be part of an existing architrave surround extending around an elevator or elevator portal or other opening.

Preferred dimensions for the magnetic strip 505 are preferably:
height h of strip—3 cm+−2cm;
thickness t of magnetic strip—4 mm+−2 mm; and
width w of magnetic strip—to suit the curtain and opening width and typically 106 cm+−15% to 138 cm+−15%.

Dimensions for the ferritic metal strip 413 are preferably:
height h1 of strip—3 cm+−2cm;
thickness t1 of metal strip—4 mm+−2 mm; and
width w1 of magnetic strip—to suit the curtain and opening width and typically 106 cm+−15% to 138 cm+−15%.

### Method of Installation

There will now be described installation of a smoke curtain assembly to a clear opening, for example an elevator door opening, having a non-ferromagnetic area immediately surrounding the perimeter of the opening, where a ferromagnetic frame needs to be fitted around the opening for the smoke curtain to attach to the magnetic strips on the curtain.

Human installers fit a metallic frame around the opening including first and second upright metal frame members 410, 412 one either side of the opening, and fit a laterally extending upper frame member 505 to the opening surround closely above the top of the opening, the upper frame member extending between the first and second upright frame side members; fit the curtain housing 400 above the opening so that when the curtain drops down vertically, the side portions of the curtain line up with the first and second side members, the curtain housing being located a distance above and spaced apart from the lateral upper frame member, so as to be as near as possible to the ceiling.

In FIG. 7 herein, in the installation shown the metallic strip 413 is rectangular in cross section in a direction along the main length axis of the strip and has a foam adhesive backing 708 so that it can be stuck to the wall or the flat surface 411, as well as being screwed with screws and wall fixings 710, 711 which compress the strip to the wall 411.

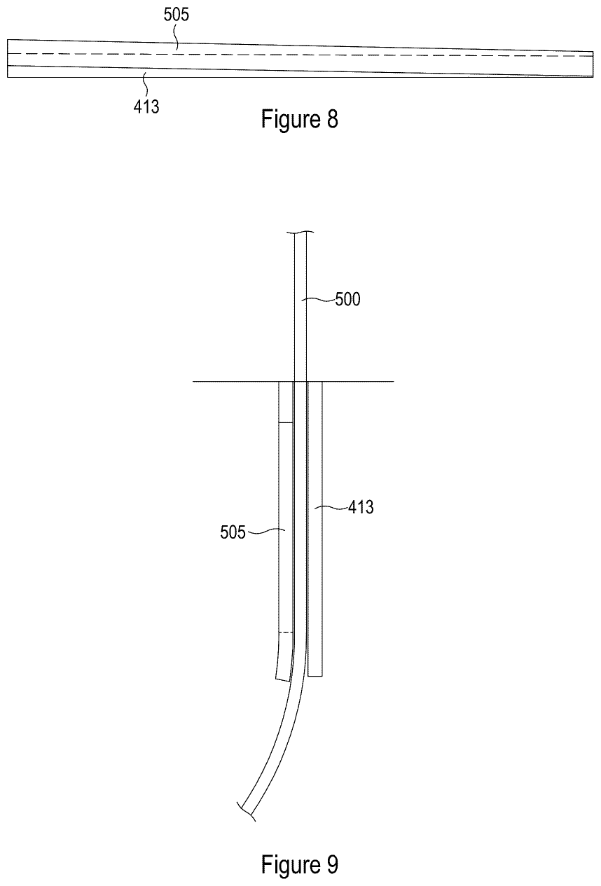

The installers drop the curtain out of the curtain housing. The installers cut a piece of magnetic strip material wide enough to extend across the width of the curtain between the first and second lateral magnetic strips of the curtain. The curtain is deployed into the extended position, which it would adopt to close off the opening during a smoke alarm. The magnetic strip is offered up to the curtain and is located so its lower edge is at an angle θ to the main length axis of the lateral magnetic strip of the frame, which has already been fitted to the opening surround. The correct position for the magnetic strip 505 on the curtain may be marked with a maker pen on the curtain prior to adhering the strip to the curtain. The magnetic strip 505 has its adhesive backing pressed to the curtain to attach the strip to the curtain at a position from the upper edge of the curtain which matches the height at which the metallic upper frame member is positioned, so that when deployed, the magnetic strip extending across the width of the curtain lies immediately adjacent and opposite to the metallic upper frame on a same horizontal plane, and so that the metallic upper frame portion 413 and the magnetic strip 505 on the curtain cross each other diagonally with an angle θ between the lower edge of the magnetic strip and the main geometric length of the upper frame strip 413 which is between 1 ° and 10 ° and preferably between 3 ° and 6 ° as shown in FIG. 8 herein.

The first lateral strip of magnetic material 505 can be attached to the curtain either with adhesive or be bonded into the curtain at the appropriate position.

The magnetic strip 505, in the best mode is a strip of flexible magnetic material having rectangular cross section as viewed in a direction along a main length axis of the magnetic strip and is covered with adhesive backing 709 to enable it to be stuck on to the film or fabric of the curtain at a position directly opposite the lateral metal strip 413 when the curtain is in fully extended position.

### Deployment of the Smoke Curtain During a Smoke Event

When there is a smoke alarm event, the smoke curtain is deployed to fall across the opening. A signal is sent from a smoke alarm to the control unit which then activates opening of the lower door panel on the curtain housing, and the rolled smoke curtain drops down under gravity, assisted by the weight of the roller 501 which is released from the curtain housing.

As the roller 501 comes down, unrolling the curtain as it drops, the magnetic upright strips on either side of the curtain are attracted magnetically to the metallic upright parts of the frame, sandwiching the curtain fabric there-between, and when the roller has dropped to a position below the laterally extending metallic strip 413 the diagonally angled magnetic strip 505 urges the curtain film towards the metallic strip 413 creating a smoke impermeable top seal across the opening, whilst the continued rolling down of the curtain across the opening seals the upright magnetic side strips 503, 504 of the curtain to the upright metallics frame strips 410, 412 on the perimeter frame of the opening creating smoke-tight side seals as the roller beam is lowered.

When in the extended deployed condition, the smoke curtain is pressed to the flat surfaces of the frame surrounding the opening, held there by the magnetic attraction between the magnetic material and the metallic material of the frame. The magnetic strips 503, 504 either side of the curtain film attract the film to the corresponding first and second upright members of the frame, and the lateral magnetic strip 505 attracts the curtain film to the lateral metallic strip 413 attached to the wall or surface surrounding the perimeter of the opening, so that the film is sealed to the frame around the opening in a smoke-impermeable manner. The space or void between the film and the wall above the upper seal and below the curtain housing is not sealed, which means that there is no need to have upright auxiliary rails extending all the way up to the box, giving a clean unobstructed appearance above the opening, as shown in FIG. 4 herein.

The strength of the magnetic attraction between the upright magnetic strips and the upright side rails or the ferromagnetic surface of the elevator surround, depending on the installation, is sufficient to positively attract and retain the curtain to the frame or directly to the surround such that air draughts or air pressure differences between regions separated by the curtain will not detach the magnetic seal, but is also weak enough such that a person on one side of the curtain can manually separate the upright magnetic seal by pushing it in order to pass between one side of the curtain and another side of the curtain so as to pass between regions separated by the curtain, without tearing the curtain fabric, and so that the upright seals re-attach one a person has passed through it.

### Retraction & Storage of the Smoke Curtain After a Smoke Event

Referring to FIGS. 8 and 9 herein, retraction of the smoke curtain back into the curtain housing can be initiated in two ways. Firstly by a central controller which controls one or a plurality of smoke curtains in an installation, to retract them after a smoke alarm event, or secondly in an emergency, by a person operating a touch sensitive electronic switch on the curtain itself, which causes the curtain to raise. In the latter event if the central smoke alarm still recognizes a smoke event, then the curtain will automatically re-extend to a deployed down condition after a predetermined time until the controller sends a signal that the building is all clear for smoke and fire. In the case of an elevator installation, elevator shafts are conduits through which smoke can quickly migrate through a building or structure and so it is important that a smoke curtain effectively seals off openings between elevator shafts and rooms or corridors, until the smoke alarm system provides a signal to retract the smoke curtains into their stored conditions when the risk of smoke distribution is over, or a decision has been made to raise the curtains anyway.

The curtain 500 is retracted back into the curtain housing 401 by the electric motor in the curtain housing rotating the roller shaft which winds the curtain in an upward direction, drawing the curtain vertically upwards. As the lateral magnetic strip 505 is magnetically attracted to the lateral metallic strip 413, this provides a force which needs to be overcome in order for the curtain to be retracted back into the curtain housing 401. To make the release of the seal between the magnetic strip 505 and the lateral metallic strip 413 more gradual and therefore requiring less force to overcome the magnetic attraction between those two components, a main length direction of the magnetic strip is angled relative to the main length direction of the metallic strip so that as the magnetic strip is pulled upwardly, the lower edge of the magnetic strip disengages from the metallic strip at one side of the magnetic strip before disengaging at the other side of the magnetic strip, and as the curtain is raised, the point of first overlap between the lower edge of the magnetic strip and the upper edge of the metallic strip moves from one side of the curtain to the other. This provides for a more gradual disengagement of the magnetic strip from the metallic strip, requiring less force than if the lower edge of the flexible magnetic strip was oriented perpendicular to the direction in which the curtain is raised. By raising the curtain in a vertical direction which is between 80 ° and 89 ° and preferably between 84 ° to 87 ° to the angle at which the lower edge of the flexible magnetic strip, the force needed in the direction perpendicular to the plane of the sheet to gradually disengage the flexible magnetic strip from the frame strip is reduced, minimising the risk of tearing the curtain material. Simply providing a stronger motor force to pull the roller up more strongly would not necessarily solve the problem of disengaging the seal, as it risks tearing the curtain material.

Referring to FIG. 8 herein, there is illustrated schematically an overlay of a laterally extending magnetic strip 505 and a laterally extending ferromagnetic metal frame strip 413 to provide a smoke-impermeable seal, where the magnetic strip and metallic strip across each other at a predetermined angle. This orientation of the seal is adopted when the smoke curtain is dropped into an extended position under gravity. As the curtain is unrolling, and as the lateral magnetic strip is fitted to the curtain at the correct height to match the laterally extending metallic strip, the magnetic strip naturally aligns with and secures to the metal strip as the curtain unrolls.

When the curtain is retracted under rotational force of the electric motor in the curtain housing 400, the curtain is pulled upwardly and needs to progressively peel away and/or slide away from the lateral metallic strip 413. However, magnetic attachment of the curtain at the point of the magnetic strip and lateral metallic strip provides a resistance which must be pulled by the curtain and this means there is a risk of the fabric tearing and/or stretching in order to overcome that force. There is a risk that the fabric will tear instead of the fabric pulling the magnetic strip away from the metallic strip. Having the main central length axis of the metallic strip crossing the main central length axis of the magnetic strip allows the magnetic strip to gradually peel away from the metallic strip, which requires less force than if the respective main length axes of the magnetic and metallic strips were to be parallel to each other.

Referring to FIG. 9 herein, there is illustrated schematically in view from one side, how the lateral magnetic strip 505 of the curtain peels away from the lateral magnetic strip 413 on the opening surround when the curtain is rolled up on its roller when being retracted back into the container.

FIG. 9 herein shows the laterally extending magnetic strip 5050 and metallic frame strip 413 partially overlapping each other as the smoke curtain is raised by a further amount showing partial disengagement of the magnetic and metallic strips to break the smoke impermeable seal. As the curtain is raised, the curtain rolls up around the roller and the magnetic strip 505 rolls up in a diametrically expanding part helical pattern around the main central axis of the roller.

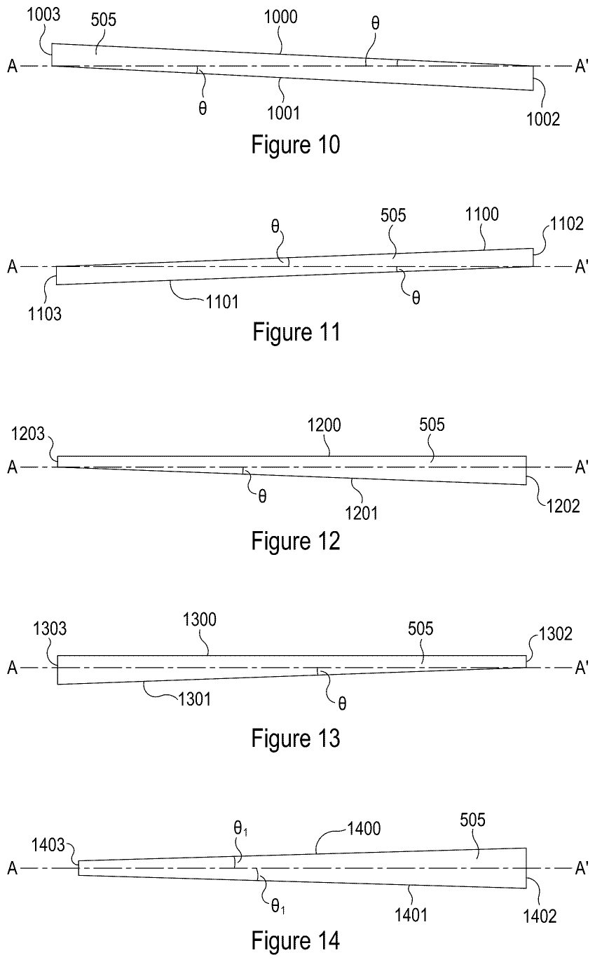

FIG. 10 herein illustrates schematically a laterally extending magnetic strip 505 according to a best mode in which the strip is angled at an angle θ of between 1° and 10° to horizontal when the curtain is hanging vertically down with its sides vertical. The strip is in the shape of a parallelogram, with upper and lower edges 1000, 1001 angled to the horizontal. In particular, when the curtain is rolled up as the weighted roller is raised after a deployment then the lower edge 1001 curls up starting at one side of the strip and gradually peeling away from the horizontal ferromagnetic material on the opening surround from right to left as shown up with the lower edge detaching gradually. This requires less force to detach the permanent magnet strip from the ferromagnetic material than if the lower edge were to be horizontal, or perpendicular to the direction of upward movement of the curtain when being rolled up for retraction.

Referring to FIGS. 11 to 17 herein, there is illustrated schematically various alternative area shapes for the magnetic strip 505 of the smoke curtain.

FIG. 11 herein illustrates schematically a laterally extending magnetic strip of a smoke curtain according to a second embodiment, which has its upper and lower edges parallel to each other and angled at between 1 ° and 10 ° and preferably between 3 ° and 6 ° to a line across the smoke curtain which is perpendicular to the upright edges of the smoke curtain when hanging down vertically. In the embodiment shown, the permanent magnet strip 1100 peels away its lower edge 1101 from left to right as viewed. The embodiment of FIG. 11 is of a similar shape as the embodiment of FIG. 10, but peeling off left to right instead of right to left as viewing a first side of the sheet, facing away from the opening.

Referring to FIG. 12 herein, there is illustrated schematically a third embodiment laterally extending magnetic strip having a straight upper boundary edge 1200 and a straight laterally extending lower boundary edge 1201, where the lower boundary edge is angled at an angle of θ in the range 1 ° to 10 ° and preferably 3 ° to 6 ° to the upper boundary edge 1200. A first side edge 1202 of the third magnetic strip at the first side of the strip is longer than a second edge 1203 at a second end of the strip. In use, as the curtain is raised, the first end of the magnetic strip pulls away from the magnetic strip on the opening surround or wall, starting at the first end, and progressively detaches along the length of the lower edge 1201 from the first end to the second end, progressively peeling the third embodiment magnetic strip away from the fixed magnetic strip above the opening.

Referring to FIG. 13 herein, there is illustrated schematically a fourth embodiment lateral extending magnetic strip having a straight upper boundary edge 1300 and a straight laterally extending lower boundary edge 1301, where the lower boundary edge is angled at an angle of θ in the range 1 ° to 10° and preferably 3 ° to 6 ° to the upper boundary edge 1300. A first side edge 1302 of the third magnetic strip at the first side of the strip is shorter than a second edge 1303 at a second end of the strip. In use, as the curtain is raised, the second end of the magnetic strip preferentially pulls away from the magnetic strip on the opening surround or wall, compared to the first end, and starting at the second end progressively detaches along the length of the lower edge 1301 from the second end to the first end, peeling the fourth embodiment magnetic strip away from the fixed magnetic strip attached to the wall or other surround above the opening, or comprising a metallic surround around the opening.

Referring to FIG. 14 herein, there is illustrated a fifth laterally extending magnetic strip of the curtain, according to a fifth embodiment comprising a quadrilateral shaped strip of permanent magnet material having an upper edge boundary 1400 which is angled relative to a line A-A′ passing perpendicularly to the first and second side edges of the curtain; a lower boundary 1401 which is angled relative to the horizontal line A-A′; a first side boundary 1402, and a second side boundary 1403. The first side boundary 1402 is relatively longer than a second side boundary 1203, so that the upper and lower boundary edges 1400, 1401 diverge away from each other towards the first side 1402 and converge towards each other towards the second side 1403. The angle θ is in the range 1 ° to 10 ° to the line A-A′ and preferably in the range 3 ° to 6 °.

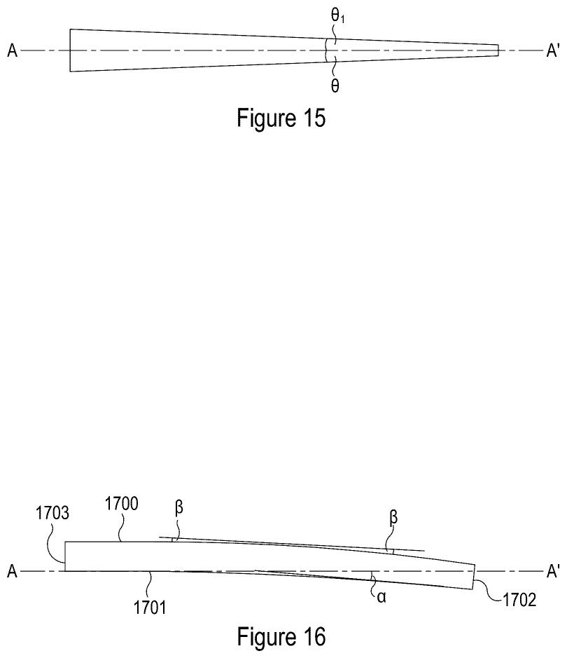

Referring to FIG. 15 herein, there is illustrated schematically a sixth laterally extending magnetic strip of the curtain, according to a sixth embodiment comprising a quadrilateral shaped strip of permanent magnet material having an upper edge boundary 1500 which is angled, in use, relative to a line A-A′ passing perpendicularly to the first and second side edges of the curtain; a lower boundary edge 1501 which is angled relative to the horizontal line A-A′; a first side boundary edge 1502, and a second side boundary edge 1503. The first side boundary edge 1502 is relatively shorter than the second side boundary edge 1503, so that the upper and lower boundary edges 1500, 1501 converge towards each other towards the first side 1502 and diverge away from each other towards the second side edge 1503. The angle θ of the lower edge to the line A-A′ which lies horizontally when the curtain is extended and with its sides hanging vertically downwards, is in the range 1 ° to 10 ° to the line A-A′ and preferably in the range 3 ° to 6 °. The angle θ₁ of the upper edge is preferably in the range 1 ° to 10 ° to the line A-A′ which lies perpendicular to the sides of the curtain when the strip is attached to the curtain, and preferably in the range 3 ° to 6 °.

Referring to FIG. 16 herein, there is illustrated schematically a seventh laterally extending magnetic strip of the curtain, according to a seventh embodiment. The seventh magnetic strip for the curtain comprises a katana blade shaped curved area flat strip of flexible permanent magnet material which can be stuck to the curtain using adhesive. The shape of the strip comprises an upper curved edge 1700, a lower curved edge 1701, the upper and lower curved edges extending spaced apart from each other across the width of the magnetic strip. The seventh magnetic strip has a curved upper edge 1700; a curved lower edge 1701; first edge 1702 at a first side: and a second edge 1703 at a second side. An angle α between a tangent to the lower edge 1702 and a line A-A′ which aligns with a line perpendicularly between the first and second sides of the curtain when the magnetic strip is fitted to the curtain is suitably in the range 1 ° to 10 °, and preferably in the range 3 ° to 6 °.

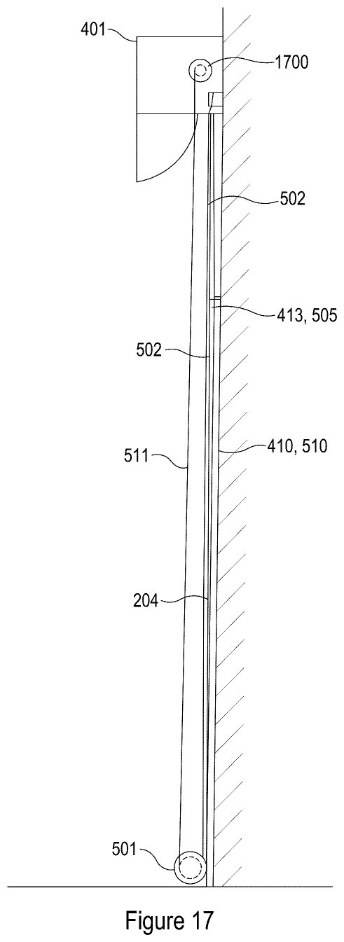

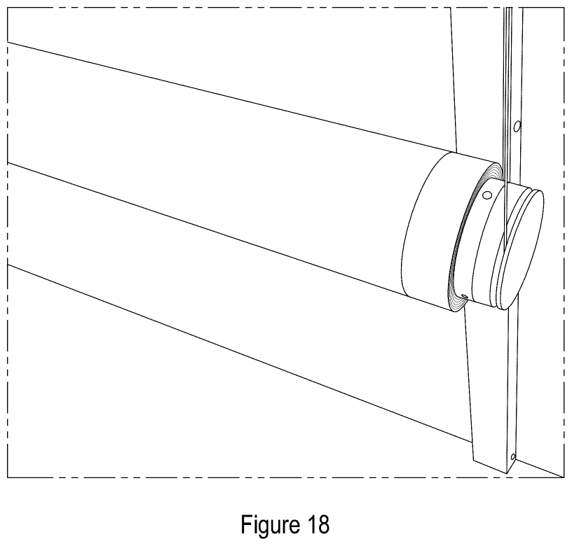

Referring to FIG. 17 herein there is illustrated schematically in view from one side the present embodiment smoke curtain in a fully deployed condition covering an aperture. The lateral magnetic strip 505 magnetically attaches to the upper cross member 413 so as to make a gas tight and smoke tight fit across the top of the covered aperture. The upright flexible magnetic strips on the curtain sides attach magnetically to the upright rails around the aperture making a smoke-tight seal at each side of the aperture. In the extended position the cords 511, 512 extend from a pair of upper capstans 1800 on a rotating motor-driven bar to the roller 501, each cord winding around a corresponding capstan, one at each end of the roller. The cords extend to an opposite side of the roller to the curtain so that as the curtain is raised or lowered the lower ends of the cords remain spaced apart from the curtain by approximately the diameter of the roller.

Referring to FIG. 18 herein, there is shown schematically a view of the roller 501 in which the curtain is in a part deployed position, with the curtain being raised or lowered, showing the magnetic strips at the sides of the curtain rolled with the curtain around the roller. The ends of the cords locate on movable wheels one each side of the roller, so the cords pull the roller up as the upper end of the cord is would around the capstans 1800 in the headbox, and the weight of the roller causes the curtain to deploy as the capstans rotate in the opposite direction to pay out the cords.

In use, the seventh magnetic strip when attached to the curtain rolls down over and adjacent to the magnetic material of the wall or opening surround above the opening search that one side of the lower edge 1701 being the first end as shown in FIG. 16, lies lower than the other, second, side of the lower edge 1701. During retraction of the curtain when the curtain is raised and rolled up around the roller, the lower part of the lower edge 1701 at the first side of the magnetic strip peels away from the magnetic material of the wall or opening surround or frame around the opening before the second end of the magnetic strip, so that the lower edge of the magnetic strip on the curtain progressively detaches from the magnetic material of the frame or opening surround from one side to another as the magnetic strip is rolled up around the roller.

In each of the above first to seventh magnetic strips, the strip may be cut or stamped from a substantially flat flexible sheet of magnetic material of uniform thickness in order to achieve the required shape and area. The sheet of magnetic material from which the strip is cut may be provided with an adhesive backing provided with a peel off cover. Alternatively, a strip of adhesive tape or fluid adhesive can be applied to one side of the magnetic strip when the strip is applied to the curtain during installation of the curtain assembly to an opening surround.

In each of the above magnetic regions of the curtain, there is a lower edge of the region which has a perimeter or a tangent to a perimeter which extends diagonally to a line A-A′ which extends perpendicular to a main geometrical central length axis of a smoke curtain, where the main geometrical central length axis hangs substantially vertically in use when the smoke curtain is deployed.

### Testing & Compliance

Individual ones of the embodiments described herein are compliant with UL 784 Standard For Air Leakage Tests Of Door Assemblies And Other Opening Protectives for a drop of 25 cm without auxiliary rails between the underside of the curtain housing and the magnetic strip above the opening.

Further, individual ones of the embodiments described herein have also been tested for operation over a stepped or protruding surround to the opening which projects up to 25 mm from the flat surface 411, with the result that where the curtain housing is not spaced apart from the surface 411, a roller which has a diameter of between 70 and 100 mm, when lowered over the protruding surround, continues to drop over the 25 mm protrusion during deployment, allowing the magnetic region on the smoke curtain to attract to the magnetic region on the opening surround and create a smoke lateral tight seal. Where the protrusion is greater than 25 mm, the curtain housing may be spaced apart from the flat upright mounting surface 411 using a spacer of similar distance protrusion to the protruding opening surround so the vertical fall or the curtain out of the headbox aligns with the vertical plane of the opening surround and/or frame.

### Advantages

The specific embodiments and methods presented herein may have the following advantages:
The specific embodiments and methods disclosed herein allow for the deployment of a smoke curtain without the need for auxiliary rails immediately beneath the curtain housing. This provides a visually less intrusive smoke curtain installation than hitherto possible.
The present specific embodiments and methods provide for a reliable and repeatable deployment of a smoke curtain without snagging or introduction of wrinkles or folds in the fabric of the extended smoke curtain.
The present specific embodiments and methods provide for a fully sealed perimeter around an opening such as an elevator entry opening doorway, window or the like, whilst avoiding having visually obtrusive auxiliary metal rails extending vertically above the aperture.
The specific embodiments herein minimise the risk of tearing of the curtain fabric when raising the curtain.

Whilst the above embodiment provides a curtain web having a region of magnetic material extending across a width of the web, and a region of ferromagnetic material located laterally around a perimeter of an opening, the skilled person will appreciate that in other embodiments, the magnetic material and ferromagnetic material may be swapped over in position so that a region of flexible ferromagnetic material is located on the web of curtain material extending across the width of the web and a region of magnetic material can be positioned opposite that on the perimeter or frame around the opening.

Whilst the specific embodiment smoke curtain assembly herein has been described as being fitted to a portal for a lift or elevator, in the general case the smoke curtain assembly may be fitted in a wide range of environments including multi-storey and high rise buildings, or ships, and including but not limited to offices, residential apartments, airports, shopping malls/shopping centres, and hotels. The smoke curtain installation may be suitable for applications other than elevators or lifts, including but not limited to portals in corridors, between corridors, across portals leading to stairwells and staircases, entrance and exit doors and the like.

1. A smoke curtain comprising:
a flexible web of material having a first side, a second side and an outer perimeter extending around said first and second sides;
said perimeter comprising an upper edge, a lower edge, a first side edge extending between said upper and edge and said lower edge, a second side edge extending between said upper edge and said lower edge, said first and second side edges spaced apart from each other; and
a region of magnetic material extending between said first and second side edges and located at a position between said upper and lower edges.

2. The smoke curtain according to claim 1, wherein said region of magnetic material comprises an upper boundary and a lower boundary, and at least one of said upper or lower boundaries extends diagonally across a line perpendicular to said first and/or second side edges.

3. The smoke curtain according to claim 1, wherein said region of magnetic material comprises an area bounded by an upper boundary and a lower boundary, each of said upper and lower boundaries extending across a width of said web of material;
wherein at least one of said upper and lower boundaries extends at an angle of between 1 ° and 10 ° relative to a line perpendicular to a said first or second side edge.

4. The smoke curtain according to claim 1, wherein said region of magnetic material comprises an area bounded by an upper boundary and a lower boundary, each of said upper and lower boundaries extending across a width of said web of material;
wherein at least one of said upper and lower boundaries extends at an angle of between 3 ° and 6 ° relative to a line perpendicular to a said first or second side edge.

5. The smoke curtain according to claim 1, wherein said region of magnetic material comprises an upper edge which extends diagonally across a line perpendicular to said first and/or second side edges; and
a lower edge which extends diagonally across a line perpendicular to said first and/or second side edges.

6. The smoke curtain according to claim 1, wherein said region of magnetic material forms a quadrilateral.

7. The smoke curtain according to claim 1, claims wherein said region of magnetic material comprises at least one straight boundary.

8. The smoke curtain according to claim 1, claims wherein said region of magnetic material comprises at least one curved boundary.

9. The smoke curtain according to claim 1, wherein said region of magnetic material comprises a magnetic strip separate from said web of smoke resistant material, said magnetic strip extending between said first and second side edges; and
further comprising an adhesive strip for adhering said magnetic strip to said web of curtain material.

10. The smoke curtain according to claim 1, wherein said region of magnetic material is flexible enough to be rolled up along with said web.

11. The smoke curtain according to claim 1, wherein said region of magnetic material is positioned at least 30 cm away from said upper edge of said web.

12. The smoke curtain according to claim 1, wherein said region of magnetic material is positioned at least 60 cm away from said upper edge of said web.

13. The smoke curtain according to claim 1, wherein said region of magnetic material is positioned 90cm or more from said upper edge of said web.

14. The smoke curtain according to claim 1, wherein said region of magnetic material comprises one or a plurality of permanent magnets.

15. The smoke curtain according to claim 1, wherein said region of magnetic material comprises a ferromagnetic material.

16. The smoke curtain according to claim 1, comprising a laterally extending securing means located at an upper end of said web for securing said smoke curtain to a curtain housing or to a wall wherein said magnetic region is spaced apart from said laterally extending securing means.

17. A smoke curtain assembly comprising:
a flexible smoke curtain comprising an elongate web of material having an upper end and a lower end, a first side edge, and a second side edge;
a container for housing said smoke curtain;
a roller for carrying said smoke curtain; and
characterised in that:
said curtain has a laterally extending magnetic strip extending across the width of the curtain between first and second sides of said curtain.

18. The smoke curtain assembly according to claim 17, wherein said laterally extending magnetic strip extends diagonally along a width and length of said curtain at an angle of between 1 ° and 10 ° to a line perpendicular to said first and/or second side edges.

19. The smoke curtain assembly according to claim 17, wherein said laterally extending magnetic strip extends diagonally along a width and length of said curtain at an angle of between 3 ° and 6 ° to a line perpendicular to said first and/or second side edges.

20. The smoke curtain assembly according to claims 17, further comprising a magnetic frame for fitment to a wall or surround around a clear opening.

21. The smoke curtain assembly according to according to claim 17, wherein said magnetic frame comprises a first upright rail of magnetic material, and a second upright rail of magnetic material.

22. The smoke curtain assembly according to claim 17, wherein said laterally extending magnetic strip extends between said first and second upright rails.

23. The smoke curtain assembly according to claim 17, wherein in use, said container is located at a distance from said a lower part of each upright rail, such that neither the first or second upright rails extend as far as a base of the container.

24. The smoke curtain assembly according to claim 17, wherein when said curtain is in extended condition, a distance between said magnetic region of said curtain, and an upper edge of said curtain is at least 30 centimetres.

25. The smoke curtain assembly according to claim 17, wherein when said curtain is in an extended condition, a distance between said magnetic region of said curtain, and an upper edge of said curtain is at least 60 centimetres.

26. The smoke curtain assembly according to claim 17, wherein when said curtain is in an extended condition, a distance between said magnetic region of said curtain, and an upper edge of said curtain is at least 90 centimetres.

27. A method of installing a smoke curtain assembly to a surrounding structure to a clear opening in a building, or ship, said method comprising:
securing a smoke curtain container to said opening surround above said opening, and spaced apart from said opening;
securing an upper part of a smoke curtain to said container, or to said opening surround; and
attaching a strip of magnetic material to said smoke curtain at a distance along said smoke curtain which is spaced apart from a location where said smoke curtain is attached to said container or said opening surround, and which is above an upper perimeter of said opening.

28. The method according to claim 27, wherein said strip of magnetic material is attached to said smoke curtain laterally across a width of said curtain.

29. The method according to claim 27, wherein said magnetic strip is attached to said smoke curtain using an adhesive strip.

30. The method according to claim 27, wherein said magnetic strip extends at an angle of between 1 ° and 10 ° to a straight line which is perpendicular to side first and second side edges of said curtain.

31. The method according to claim 27, wherein said magnetic strip comprises a permanent magnet.

32. The method according to claim 27, wherein said magnetic strip is flexible enough to be rolled up along with said curtain when said curtain is rolled into a spiral.

33. The method according to claim 27, wherein said container is spaced apart from said magnetic strip attached to said curtain, by at distance at least as high as a height of said container.
